(19) United States
(12) Patent Application Publication
(10) Pub. No.: US 2025/0149211 A1
(43) Pub. Date: May 8, 2025

(54) CHIP RESISTOR

(71) Applicant: YAGEO CORPORATION, Kaohsiung City (TW)

(72) Inventors: Shen-Li HSIAO, Kaohsiung City (TW); Po-Hsun SHIH, Kaohsiung City (TW); Kuang-Cheng LIN, Kaohsiung City (TW)

(21) Appl. No.: 18/543,875

(22) Filed: Dec. 18, 2023

(30) Foreign Application Priority Data
Nov. 3, 2023 (TW) 112142443

(51) Int. Cl. H01C 17/00; H01C 1/142

(52) U.S. Cl. CPC H01C 17/006; H01C 1/142

(57) ABSTRACT

A chip resistor includes a substrate, first to fourth electrodes, a resistance layer, a resin electrode layer, first and second insulating protective layers, and first and second external electrode layers. The first and second electrodes are respectively disposed on two opposite edge areas of a front surface of the substrate. The resistance layer extends from the first electrode to the second electrode. The first insulating protective layer completely covers the resistance layer. The resin electrode layer includes first to third portions respectively covering the first and second electrodes, and a portion of the first insulating protective layer. The second insulating protective layer completely covers the third portion and partially covers the first and second portions. The third and fourth electrodes are disposed on a back surface of the substrate. The first and second external electrode layers respectively connect the first and third electrodes, and the second and fourth electrodes.

### RELATED APPLICATIONS

This application claims priority to Taiwan Application Serial Number 112142443, filed Nov. 3, 2023, which is herein incorporated by reference.

### BACKGROUND

### Field of Invention

The present disclosure relates to a passive device, and more particularly, to a chip resistor.

### Description of Related Art

A conventional chip resistor mainly includes a pair of electrodes and a resistance layer spanning between the pair of electrodes. In the conventional chip resistor, laser cutting processing or photolithography and etching is used to change the current path of the resistance layer. According to Ohm's law of resistance, the longer the current path is, the greater the resistance is. Currently, when the same resistance material is used, there are generally two methods to increase the resistance of the chip resistor. The first method is to reduce the thickness of the resistance layer, and the second method is to increase the number of laser cutting or use photolithography and etching to increase the winding pattern of the resistance layer.

If the resistance value of the chip resistor is increased by reducing the thickness of the resistance layer, the resistance layer may be too thin, resulting in a decrease in the power tolerance and weathering resistance of the product. As a result, the chip resistor is prone to failure due to electrostatic discharge (ESD) or damage due to the impact of a voltage surge.

If the method of increasing the winding pattern of the resistance layer is used, the thickness of the resistance layer needs to be increased first, and then the laser or etching is used to form the winding pattern of the resistance layer. In addition, increasing the number of cuts will cause the spacing between the lines of the winding pattern of the resistance layer to be too close, for example, the line gap may be less than 7 μm. The thermal effect of laser processing will affect the resistance layer, which reduces the stability of electrical performance of the chip resistor. If the photolithography and etching processes are used, it is difficult to achieve fine line widths by etching, and the cost is much higher than that of laser.

Furthermore, chip resistors are marked with specifications for rated power and maximum operating voltage in the specification sheet. The specification means that when the resistance of the product is greater than a certain resistance value, the product specifications only apply to the maximum operating voltage and not to the rated power. In order to increase the withstand voltage of the product under the same rated power, it has to increase the current path of the resistance layer, that is, a resistance layer with a more meandering circuit pattern is needed, to reduce the potential on the circuit of the resistance layer, thereby reducing the voltage difference per unit length. However, according to Ohm's law, increasing the current path of the resistance layer will decrease the cross-sectional area of the current path of the resistance layer, thus resulting in a decrease in the power stability of the product.

### SUMMARY

Therefore, one objective of the present disclosure is to provide a chip resistor, which reduces a first electrode and a second electrode on a front surface of a substrate to increase an area of a resistance layer covering the front surface of the substrate. Thus, the resistance layer has more space to design more bending curves, thereby increasing the resistance of the resistor and reducing the voltage difference per unit length of the resistor.

Another objective of the present disclosure is to provide a chip resistor, in which a first portion and a second portion of a resin electrode layer can protect the first electrode and the second electrode inside the chip resistor from the influence of environmental moisture and sulfur gas, and can be used for electroplating connection of external electrodes. A third portion disposed above the resistance layer can be beneficial to the heat dissipation and metallic waterproofing of the chip resistor.

According to the aforementioned objectives, the present disclosure provides a chip resistor, which includes a substrate, a first electrode, a second electrode, a resistance layer, a first insulating protective layer, a resin electrode layer, a second insulating protective layer, a third electrode, a fourth electrode, a first external electrode layer, and a second external electrode layer. The substrate includes a front surface and a back surface. The front surface comprises a first edge area and a second edge area opposite to each other. The first electrode and the second electrode are respectively disposed on a portion of the first edge area and a portion of the second edge area. The resistance layer is disposed on the front surface and extends from the first electrode to the second electrode. The first insulating protective layer completely covers the resistance layer. The resin electrode layer includes a first portion, a second portion, and a third portion. The first portion covers the first electrode and a portion of the first insulating protective layer adjacent to the first electrode. The second portion covers the second electrode and a portion of the first insulating protective layer adjacent to the second electrode. The third portion covers a portion of the first insulating protective layer which is on the resistance layer. The first portion, the second portion, and the third portion are separated from each other. The second insulating protective layer completely covers the third portion and partially covers the first portion and the second portion. The third electrode and the fourth electrode are disposed on the back surface and opposite to the first electrode and the second electrode respectively. The first external electrode layer is from the first electrode through a first side surface of the substrate to the third electrode. The second external electrode layer is from the second electrode through a second side surface of the substrate to the fourth electrode.

According to one embodiment of the present disclosure, each of the first electrode and the second electrode includes a first section, a second section, and a third section. The first section and the second section are respectively connected to two opposite ends of the third section and protrude from the third section. The third section of the first electrode and the third section of the second electrode respectively extend along one side of the first side surface and one side of the second side surface. The first electrode has a C-like structure, and the second electrode has an inverted C-like structure.

According to one embodiment of the present disclosure, each of the first sections and the second sections has a length greater than about 50 μm and smaller than about 250 μm, and each of the third sections has a length greater than about 50 μm and smaller than about 150 μm.

According to one embodiment of the present disclosure, each of the first electrode and the second electrode is a rectangular structure, and the first electrode and the second electrode extend toward the second edge area and the first edge area respectively. Each of the first electrode and the second electrode has a length greater than about 50 μm and smaller than about 250 μm, and a width greater than about 50 μm and smaller than about 200 μm.

According to one embodiment of the present disclosure, the first electrode and the second electrode are respectively located at two diagonally opposite corners of the front surface. The resistance layer has a first U-shaped groove and a second U-shaped groove respectively exposing a portion of the first electrode and a portion of the second electrode. A front end of the first electrode is spaced apart from an inner surface of the first U-shaped groove, and a front end of the second electrode is spaced apart from an inner surface of the second U-shaped groove.

According to one embodiment of the present disclosure, a distance between each of the first electrode and the second electrode and an adjacent long side of the front surface is greater than or equal to 0 μm and smaller than about 250 μm.

According to one embodiment of the present disclosure, materials of the first electrode and the second electrode are copper, copper-nickel alloy, nickel-phosphorus alloy, or sintered silver paste containing silver and glass, and materials of the third electrode and the fourth electrode are epoxy resin and silver.

According to one embodiment of the present disclosure, a material of the resistance layer is nickel-chromium alloy, copper-nickel alloy, nickel-chromium-silicon alloy, nickel-chromium-aluminum alloy, nickel-chromium-aluminum-silicon alloy, nickel-chromium-aluminum-yttrium alloy, nickel-chromium-tantalum-molybdenum alloy, tantalum nitride, copper-manganese-tin alloy, or copper-manganese-nickel alloy.

According to one embodiment of the present disclosure, a material of the first insulating protective layer is silicon oxide, tantalum oxide, or silicon nitride, and a material of the second insulating protective layer is epoxy resin, polyimide (PI), or resin.

According to one embodiment of the present disclosure, the resin electrode layer is made of epoxy resin and silver.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1A to FIG. 1I are schematic flow diagrams illustrating a manufacturing process of a chip resistor in accordance with one embodiment of the present disclosure.

FIG. 2 is a schematic diagram illustrating a configuration of a first electrode, a second electrode, and a resistance layer of a chip resistor in accordance with another embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms “connected”, “electrically connected”, or the like between two components referred to in the present disclosure are not limited to the direct connection or electrical connection of the two components, and may also include indirect connection or electrical connection as required.

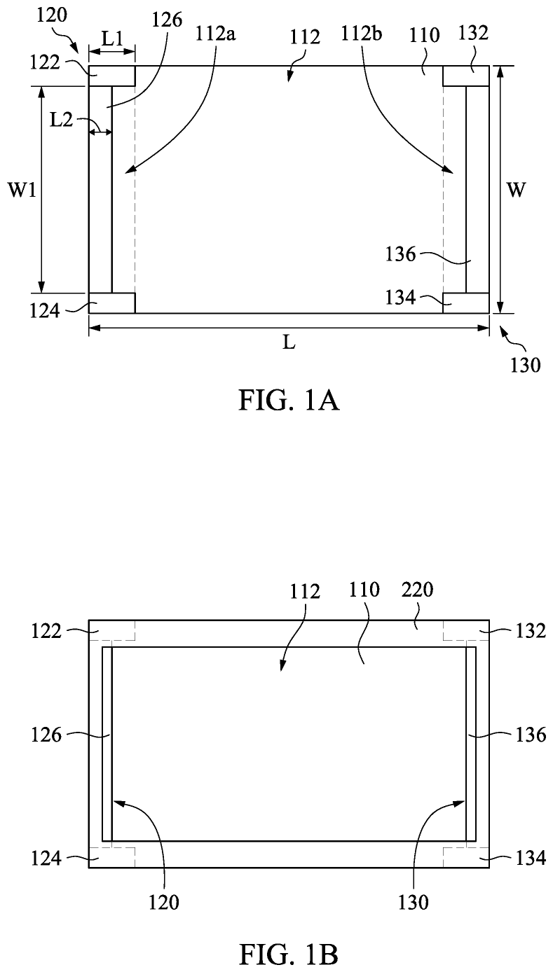

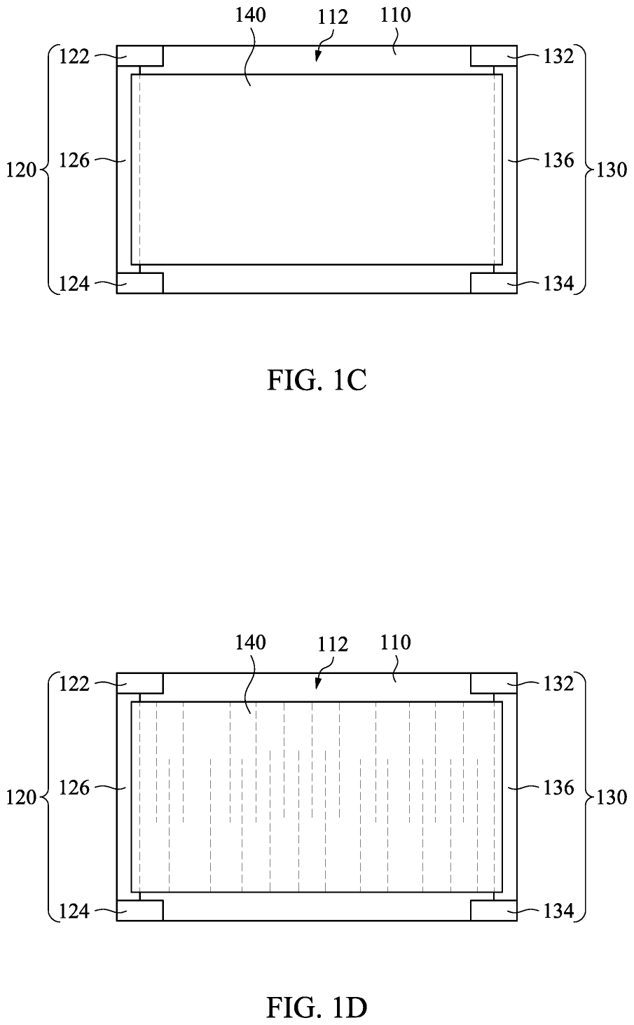

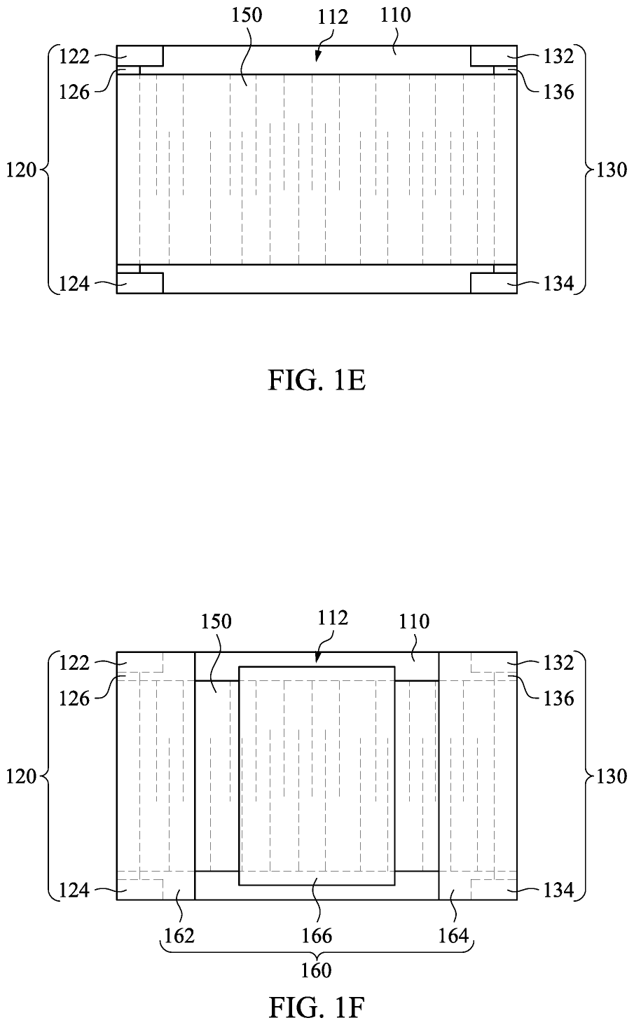

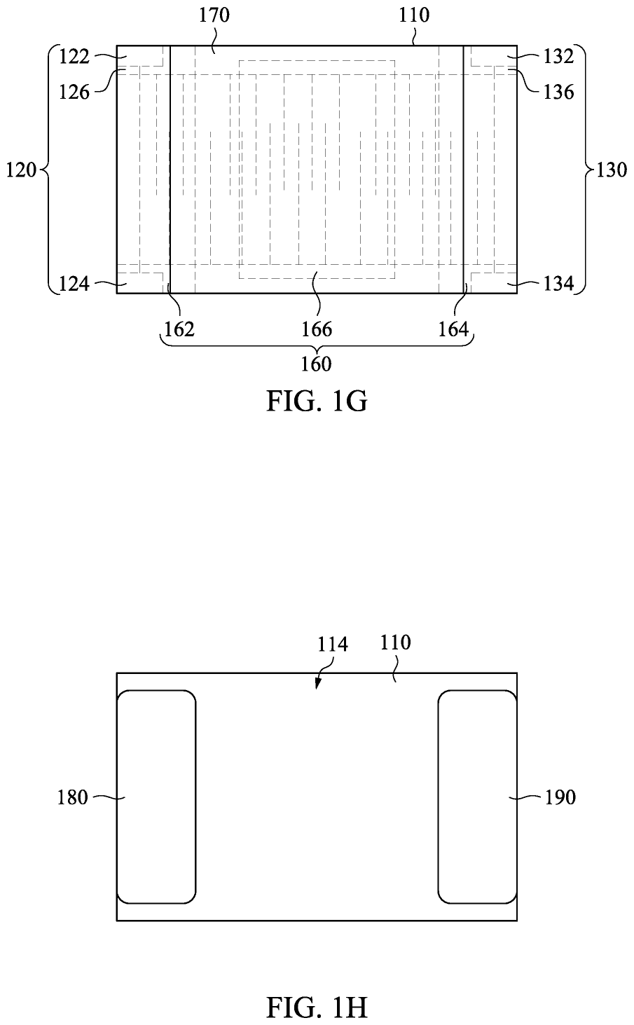

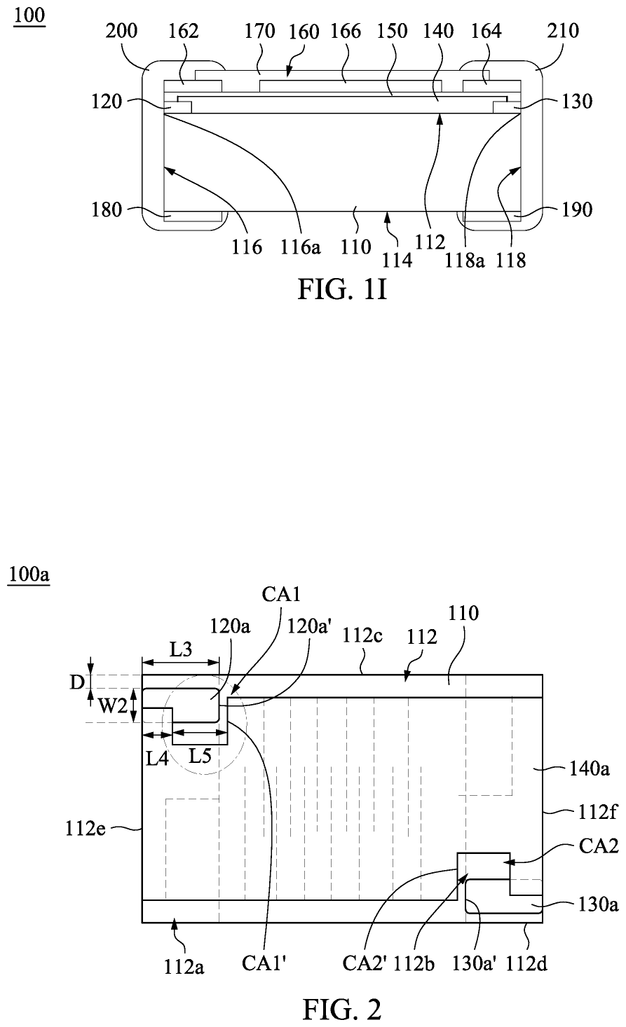

Referring to FIG. 1A to FIG. 1I, FIG. 1A to FIG. 1I are schematic flow diagrams illustrating a manufacturing process of a chip resistor 100 in accordance with one embodiment of the present disclosure. As shown in FIG. 1I, the chip resistor 100 may mainly include a substrate 110, a first electrode 120, a second electrode 130, a resistance layer 140, a first insulating protective layer 150, a resin electrode layer 160, a second insulating protective layer 170, a third electrode 180, a fourth electrode 190, a first external electrode layer 200, and a second external electrode layer 210.

In the manufacturing the chip resistor 100, the substrate 110 may be provided first. The substrate 110 may be a flat plate structure. For example, as shown in FIG. 1A, the substrate 110 may be a rectangular flat plate structure and has a length L and a width W. As shown in FIG. 1I, the substrate 110 has a front surface 112 and a back surface 114 that are opposite to each other, and a first side surface 116 and a second side surface 118 that are opposite to each other, in which the first side surface 116 and the second side surface 118 are connected between the front surface 112 and the back surface 114. Both the front surface 112 and the back surface 114 may be flat. The front surface 112 of the substrate 110 includes a first edge area 112a and a second edge area 112b that are opposite to each other. Specifically, the first edge area 112a and the second edge area 112b are located at two opposite sides of the substrate 110 in the direction of the length L. The first edge area 112a and the second edge area 112b are both rectangular areas. The substrate 110 may be a ceramic substrate. For example, a material of the substrate 110 may be aluminum oxide, aluminum nitride, boron nitride, silicon carbide, or a glass-containing material.

Next, as shown in FIG. 1A, the first electrode 120 and the second electrode 130 may be formed respectively on the first edge area 112a and the second edge area 112b of the front surface 112 of the substrate 110 by printing or sputtering. The first electrode 120 and the second electrode 130 are only formed on a portion of the first edge area 112a and a portion of the second edge area 112b respectively. That is, the area occupied by the first electrode 120 and the second electrode 130 on the front surface 112 of the substrate 110 is smaller than that of the front surface electrode of a conventional resistor.

For example, referring to FIG. 1A and FIG. 1I simultaneously, the first electrode 120 may include a first section 122, a second section 124, and a third section 126, and the second electrode 130 may include a first section 132, a second section 134, and a third section 136. The third section 126 of the first electrode 120 extends along one side 116a of the first side surface 116, and the third section 136 of the second electrode 130 extends along one side 118a of the second side surface 118. The first section 122 and the second section 124 of the first electrode 120 are respectively connected to two opposite ends of the third section 126 and protrude from the third section 126 toward the second edge area 112b. The first section 132 and the second section 134 of the second electrode 130 are respectively connected to two opposite ends of the third section 136 and protrude from the third section 136 toward the first edge area 112a. The first electrode 120 and the second electrode 130 may be mirror symmetrical. For example, the first electrode 120 has a C-like structure, and the second electrode 130 has an inverted C-like structure.

As shown in FIG. 1A, each of the first section 122 and the second section 124 of the first electrode 120, and the first section 132 and the second section 134 of the second electrode 130 has a length L1, and each of the third section 126 of the first electrode 120 and the third section 136 of the second electrode 130 has a length L2 and a width W1. In some examples, the length L1 is greater than about 50 μm and smaller than about 250 μm, and the length L2 is greater than about 50 μm and smaller than about 150 μm. In addition, materials of the first electrode 120 and the second electrode 130 may be a low-resistance material, such as copper, copper-nickel alloy, nickel-phosphorus alloy, or sintered silver paste containing silver and glass. The first electrode 120 and the second electrode 130 may be an integrally formed structure.

Next, referring to FIG. 1B and FIG. 1C, the resistance layer 140 may be fabricated. In some examples, a peelable shielding layer 220 may be formed on the front surface 112 of the substrate 110 to shield the coating. The shielding layer 220 may shield the areas of the front surface 112 where the resistance layer 140 is not to be formed. The shielding layer 220 covers a portion of the first electrode 120 and a portion of the second electrode 130. As shown in FIG. 1B, for example, the shielding layer 220 may completely cover the first section 122 and the second section 124 of the first electrode 120 and the first section 132 and the second section 134 of the second electrode 130, and partially cover the third sections 126 and 136, such that portions of the third sections 126 and 136 are exposed. For example, a material of the shielding layer 220 is removable ink or photoresist. The shielding layer 220 may be formed by printing or photolithography, for example.

Then, a layer of resistance material may be formed to cover the front surface 112 of the substrate 110 and the shielding layer 220 by, for example, sputtering. Subsequently, the shielding layer 220 is removed by solvent or water washing. As shown in FIG. 1C, when the shielding layer 220 is removed, the resistance material on the shielding layer 220 is also removed, and the resistance layer 140 with a predetermined pattern is formed on the front surface 112 of the substrate 110. The resistance layer 140 extends from the first electrode 120 to the second electrode 130, and is in contact with and electrically connected to the first electrode 120 and the second electrode 130. For example, a material of the resistance layer 140 may be metal alloy, such as nickel-chromium alloy, copper-nickel alloy, nickel-chromium-silicon alloy, nickel-chromium-aluminum alloy, nickel-chromium-aluminum-silicon alloy, nickel-chromium-aluminum-yttrium alloy, nickel-chromium-tantalum-molybdenum alloy, tantalum nitride, copper-manganese-tin alloy, or copper-manganese-nickel alloy. The present disclosure can use other suitable resistance materials and is not limited thereto.

By reducing the electrode space, the area covered by the resistance layer 140 on the front surface 112 of the substrate 110 can be increased, which allows the resistance layer 140 to have more space to design more bending curves, such that the resistance value of the chip resistor 100 can be increased, and the voltage difference per unit length of the resistance layer 140 can be reduced. In a conventional resistor, a length of an electrode is generally ⅙ to ¼ of a long side of a substrate, and a length of a resistance area is generally ½ to ⅔ of the long side of the substrate. A length of the electrode of the chip resistor 100 in the present embodiment can be shortened by 50% compared to the length of the electrode of the conventional resistor, and a length of the resistance area can be increased by 15%. According to the 0402 size design, which is a length of 0.4 mm and a width of 0.2 mm, a basic operating voltage of a single resistor product can be increased from 50 V to over 60 V.

Next, a resistance adjustment operation may be selectively performed according to the product requirements of the chip resistor 100. In some examples, as shown in FIG. 1D, the resistance layer 140 is patterned by using laser or physical processing to adjust the resistance of the chip resistor 100.

As shown in FIG. 1E, after the resistance adjustment operation of the chip resistor 100 is completed, the first insulating protective layer 150 is formed on the front surface 112 of the substrate 110 by sputtering or chemical vapor deposition. The first insulating protective layer 150 completely covers the resistance layer 140, and covers a portion of the third section 126 of the first electrode 120 and a portion of the third section 136 of the second electrode 130. In some examples, a material of the first insulating protective layer 150 is silicon oxide, tantalum oxide, or silicon nitride.

Next, the conductive resin electrode layer 160 is formed by printing, for example. In some examples, as shown in FIG. 1F, the resin electrode layer 160 includes a first portion 162, a second portion 164, and a third portion 166, in which the first portion 162, the second portion 164, and the third portion 166 are physically separated from each other. The first portion 162 covers the first electrode 120 and a portion of the first insulating protective layer 150 that is adjacent to the first electrode 120. The second portion 164 covers the second electrode 130 and a portion of the first insulating protective layer 150 that is adjacent to the second electrode 130. The first portion 162 and the second portion 164 may be respectively connected to the first electrode 120 and the second electrode 130. With the arrangement of the first portion 162 and the second portion 164, the first electrode 120 and the second electrode 130 can be protected from the influence of environmental moisture and sulfur gas, and the external electrode plating connection can be achieved at the same time. The third portion 166 is located between the first portion 162 and the second portion 164 and covers a portion of the first insulating protective layer 150 on the resistance layer 140. The third portion 166 is disposed above the resistance layer 140 to enhance the heat dissipation performance of the chip resistor 100 and provide metallic waterproofing. In some examples, a material of the resin electrode layer 160 is epoxy resin and silver.

Subsequently, as shown in FIG. 1G, a second insulating protective layer 170 is formed by using, for example, printing. The second insulating protective layer 170 completely covers the third portion 166 of the resin electrode layer 160 and partially covers the first portion 162 and the second portion 164 of the resin electrode layer 160. For example, a material of the second insulating protective layer 170 may be epoxy resin, polyimide, or resin.

Next, as shown in FIG. 1H, the third electrode 180 and the fourth electrode 190 may be formed on the back surface 114 of the substrate 110 by, for example, printing. The third electrode 180 and the fourth electrode 190 are opposite to the first electrode 120 and the second electrode 130 respectively. Shapes of the third electrode 180 and the fourth electrode 190 may be different from or the same as shapes of the first electrode 120 and the second electrode 130. For example, materials of the third electrode 180 and the fourth electrode 190 may be epoxy resin and silver.

Then, as shown in FIG. 1I, the first external electrode layer 200 and the second external electrode layer 210 of the chip resistor 100 may be fabricated. The first external electrode layer 200 extends from the first electrode 120 on the front surface 112 of the substrate 110 through the first side surface 116 of the substrate 110 to the third electrode 180 on the back surface 114. The second external electrode layer 210 extends from the second electrode 130 on the front surface 112 through the second side surface 118 of the substrate 110 to the fourth electrode 190 on the back surface 114. In some examples, the first external electrode layer 200 covers the first electrode 120 and the third electrode 180 to form a C-like structure; and the second external electrode layer 210 covers the second electrode 130 and the fourth electrode 190 to form a inverted C-like structure.

In some examples, a nickel-chromium layer is first formed on the first side surface 116 and the second side surface 118 of the substrate 110 by, for example, sputtering as a side connection layer, and then a nickel layer and a tin layer are sequentially formed, or a nickel layer, a copper layer, another nickel layer, and a tin layer are sequentially formed by, for example, electroplating. Therefore, the first external electrode layer 200 and the second external electrode layer 210 may include a nickel-chromium layer, a nickel layer, and a tin layer stacked in sequence, or may include a nickel-chromium layer, a nickel layer, a copper layer, another nickel layer, and a tin layer stacked in sequence.

The configuration of the electrodes and the resistance layer of the chip resistor of the present disclosure can have different designs. Referring to FIG. 2, FIG. 2 is a schematic diagram illustrating a configuration of a first electrode 120a, a second electrode 130a, and a resistance layer 140a of a chip resistor 100a in accordance with another embodiment of the present disclosure. In the present embodiment, the first electrode 120a and the second electrode 130a are respectively disposed on a portion of a first edge area 112a and a portion of a second edge area 112b of a front surface 112 of a substrate 110. Therefore, the area occupied by the first electrode 120a and the second electrode 130a on the front surface 112 of the substrate 110 is smaller than that of electrodes on a front surface of a conventional resistor.

In some examples, the first electrode 120a and the second electrode 130a are respectively located at two diagonally opposite corners of the front surface 112 of the substrate 110. Each of the first electrode 120a and the second electrode 130a has a rectangular structure. The first electrode 120a extends toward the second edge area 112b. The second electrode 130a extends toward the first edge area 112a. Each of the first electrode 120a and the second electrode 130a has a length L3 and a width W2. In addition, there is a distance D between the first electrode 120a and an adjacent long side 112c of the front surface 112, and there is also a distance D between the second electrode 130a and an adjacent long side 112d of the front surface 112. In some examples, the length L3 is greater than about 50 μm and smaller than about 250 μm, the width W2 is greater than about 50 μm and smaller than about 200 μm, and the distance D is greater than or equal to 0 μm and smaller than about 250 μm.

As shown in FIG. 2, the resistance layer 140a has a first U-shaped groove CA1 and a second U-shaped groove CA2 respectively located at two diagonally opposite corners of the resistance layer 140a. The first U-shaped groove CA1 is located on the first electrode 120a and exposes a portion of the first electrode 120a. The second U-shaped groove CA2 is located on the second electrode 130a and exposes a portion of the second electrode 130a. The first U-shaped groove CA1 is separated from an adjacent short side 112e of the front surface 112 by a length L4 in a length direction of the first electrode 120a, and has a length L5 in the length direction of the first electrode 120a. Similarly, the second U-shaped groove CA2 is separated from an adjacent short side 112f of the front surface 112 by a length L4 in a length direction of the second electrode 130a, and has a length L5 in the length direction of the second electrode 130a. The length L5 is greater than the difference between the length L3 and the length L4. That is, a front end 120a′ of the first electrode 120a is spaced apart from an inner surface CA1′ of the first U-shaped groove CA1, and a front end 130a′ of the second electrode 130a is spaced apart from an inner surface CA2′ of the second U-shaped groove CA2.

According to the aforementioned embodiments, one advantage of the present disclosure is that the chip resistor of the present disclosure reduces a first electrode and a second electrode on a front surface of a substrate to increase an area of a resistance layer covering the front surface of the substrate. Therefore, the resistance layer has more space to design more bending curves, thereby increasing the resistance of the resistor and reducing the voltage difference per unit length of the resistor.

Another advantage of the present disclosure is that a first portion and a second portion of a resin electrode layer of the chip resistor of the present disclosure can protect the first electrode and the second electrode inside the chip resistor from the influence of environmental moisture and sulfur gas, and can be used for electroplating connection of external electrodes. A third portion disposed above the resistance layer can be beneficial to the heat dissipation and metallic waterproofing of the chip resistor.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A chip resistor, comprising:
a substrate comprising a front surface and a back surface, wherein the front surface comprises a first edge area and a second edge area opposite to each other;
a first electrode and a second electrode respectively disposed on a portion of the first edge area and a portion of the second edge area;
a resistance layer disposed on the front surface and extending from the first electrode to the second electrode;
a first insulating protective layer completely covering the resistance layer;
a resin electrode layer, wherein the resin electrode layer comprises:
a first portion covering the first electrode and a portion of the first insulating protective layer adjacent to the first electrode;
a second portion covering the second electrode and a portion of the first insulating protective layer adjacent to the second electrode; and
a third portion covering a portion of the first insulating protective layer which is on the resistance layer, wherein the first portion, the second portion, and the third portion are separated from each other;
a second insulating protective layer completely covering the third portion and partially covering the first portion and the second portion;
a third electrode and a fourth electrode disposed on the back surface and opposite to the first electrode and the second electrode respectively;
a first external electrode layer from the first electrode through a first side surface of the substrate to the third electrode; and
a second external electrode layer from the second electrode through a second side surface of the substrate to the fourth electrode.

2. The chip resistor of claim 1, wherein each of the first electrode and the second electrode comprises a first section, a second section, and a third section, the first section and the second section are respectively connected to two opposite ends of the third section and protrude from the third section, and the third section of the first electrode and the third section of the second electrode respectively extend along one side of the first side surface and one side of the second side surface, wherein the first electrode has a C-like structure, and the second electrode has an inverted C-like structure.

3. The chip resistor of claim 2, wherein each of the first sections and the second sections has a length greater than 50 μm and smaller than 250 μm, and each of the third sections has a length greater than 50 μm and smaller than 150 μm.

4. The chip resistor of claim 1, wherein each of the first electrode and the second electrode is a rectangular structure, the first electrode and the second electrode extend toward the second edge area and the first edge area respectively, and each of the first electrode and the second electrode has a length greater than 50 μm and smaller than 250 μm, and a width greater than 50 μm and smaller than 200 μm.

5. The chip resistor of claim 4, wherein the first electrode and the second electrode are respectively located at two diagonally opposite corners of the front surface, the resistance layer has a first U-shaped groove and a second U-shaped groove respectively exposing a portion of the first electrode and a portion of the second electrode, a front end of the first electrode is spaced apart from an inner surface of the first U-shaped groove, and a front end of the second electrode is spaced apart from an inner surface of the second U-shaped groove.

6. The chip resistor of claim 5, wherein a distance between each of the first electrode and the second electrode and an adjacent long side of the front surface is greater than or equal to 0 μm and smaller than 250 μm.

7. The chip resistor of claim 1, wherein materials of the first electrode and the second electrode are copper, copper-nickel alloy, nickel-phosphorus alloy, or sintered silver paste containing silver and glass, and materials of the third electrode and the fourth electrode are epoxy resin and silver.

8. The chip resistor of claim 1, wherein a material of the resistance layer is nickel-chromium alloy, copper-nickel alloy, nickel-chromium-silicon alloy, nickel-chromium-aluminum alloy, nickel-chromium-aluminum-silicon alloy, nickel-chromium-aluminum-yttrium alloy, nickel-chromium-tantalum-molybdenum alloy, tantalum nitride, copper-manganese-tin alloy, or copper-manganese-nickel alloy.

9. The chip resistor of claim 1, wherein a material of the first insulating protective layer is silicon oxide, tantalum oxide, or silicon nitride, and a material of the second insulating protective layer is epoxy resin, polyimide, or resin.

10. The chip resistor of claim 1, wherein the resin electrode layer is made of epoxy resin and silver.

11. A chip resistor, comprising:
a substrate comprising a front surface and a back surface, wherein the front surface comprises a first edge area and a second edge area opposite to each other;
a first electrode and a second electrode respectively disposed on a portion of the first edge area and a portion of the second edge area;
a resistance layer disposed on the front surface and extending from the first electrode to the second electrode;
a first insulating protective layer completely covering the resistance layer;
a resin electrode layer, wherein the resin electrode layer comprises:
a first portion covering the first electrode and a portion of the first insulating protective layer adjacent to the first electrode; and
a second portion covering the second electrode and a portion of the first insulating protective layer adjacent to the second electrode, wherein the second portion and the first portion are separated from each other;
a second insulating protective layer covering the first insulating protective layer between the first portion and the second portion and partially covering the first portion and the second portion;
a third electrode and a fourth electrode disposed on the back surface and opposite to the first electrode and the second electrode respectively;
a first external electrode layer from the first electrode through a first side surface of the substrate to the third electrode; and
a second external electrode layer from the second electrode through a second side surface of the substrate to the fourth electrode.

12. The chip resistor of claim 11, wherein each of the first electrode and the second electrode comprises a first section, a second section, and a third section, the first section and the second section are respectively connected to two opposite ends of the third section and protrude from the third section, and the third section of the first electrode and the third section of the second electrode respectively extend along one side of the first side surface and one side of the second side surface, wherein the first electrode has a C-like structure, and the second electrode has an inverted C-like structure.

13. The chip resistor of claim 12, wherein each of the first sections and the second sections has a length greater than 50 μm and smaller than 250 μm, and each of the third sections has a length greater than 50 μm and smaller than 150 μm.

14. The chip resistor of claim 11, wherein each of the first electrode and the second electrode is a rectangular structure, the first electrode and the second electrode extend toward the second edge area and the first edge area respectively, and each of the first electrode and the second electrode has a length greater than 50 μm and smaller than 250 μm, and a width greater than 50 μm and smaller than 200 μm.

15. The chip resistor of claim 14, wherein the first electrode and the second electrode are respectively located at two diagonally opposite corners of the front surface, the resistance layer has a first U-shaped groove and a second U-shaped groove respectively exposing a portion of the first electrode and a portion of the second electrode, a front end of the first electrode is spaced apart from an inner surface of the first U-shaped groove, and a front end of the second electrode is spaced apart from an inner surface of the second U-shaped groove.
